(19) United States
(12) Patent Application Publication
(10) Pub. No.: US 2010/0111507 A1
(43) Pub. Date: May 6, 2010

(54) MOBILE DIGITAL SIGNAL TRANSCEIVING DEVICE

(75) Inventors: WEN-CHAO SHEN, PA TEH CITY (TW); WEN-YEN SHEN, TAOYUAN CITY (TW); SHUN-CHING CHEN, Yingge Township (TW)

Correspondence Address: ROSENBERG, KLEIN & LEE, 3458 ELLICOTT CENTER DRIVE-SUITE 101, ELLICOTT CITY, MD, 21043, US

(73) Assignee: AZURE SHINE INTERNATIONAL INC., TAOYUAN (TW)

(21) Appl. No.: 12/510,450

(22) Filed: Jul. 28, 2009

(30) Foreign Application Priority Data
Oct. 31, 2008 (TW) 097141965

(51) Int. Cl. H04N 7/01

(52) U.S. Cl. 386/131; 348/441; 348/724; 386/E05.003; 348/E07.003

(57) ABSTRACT

A mobile digital signal transceiving device comprises a multimedia interface, a processing unit and a radio frequency (RF) signal transmitter. The multimedia interface reads at least one multimedia data stored in at least one multimedia memory device. The processing unit transfers the multimedia data into a terrestrial broadcast data in a digital video broadcasting-terrestrial (DVB-T) data format, and modulates the terrestrial broadcast data in order to generate an RF signal. The RF signal transmitter transmits the RF signal so that the RF signal may be received by at least one mobile multimedia device.

This application claims the benefit of Taiwan Patent Application Serial No. 097141965, filed Oct. 31, 2008, the subject matter of which is incorporated herein by reference.

### BACKGROUND OF THE INVENTION

(1) Field of the Invention

The invention relates to a device for mobile digital signal transceiving and, more particularly, to a device that transceives multimedia data of a mobile multimedia memory apparatus in a DVB-T (digital video broadcasting-terrestrial) data format.

(2) Description of the Prior Art

Satellite technology has made our life more convenient in various ways. In our daily life, products that support global satellite positioning, satellite telecommunicating, satellite broadcasting, satellite navigating or the like, have brought people closer geographically, which have put the world under a global village. Moreover, satellite broadcasting has realized “real-time” TV programs in the broadcasting industry, which renders it possible to play various programs at every corner of the world.

In the prior art, the satellite broadcasting technology may generally be classified into stationary broadcasting and mobile broadcasting. In stationary broadcasting, it is required to have a DVB-S/DVB-T (digital video broadcasting-satellite/digital video broadcasting-terrestrial) signal-transceiving base station constructed on the ground or a suitable fixed construction. Furthermore, satellite parameters are downloaded so as to direct an antenna toward a desired satellite, thereby establishing a bi-directional signal and data link between the base station and the satellite. However, due to the lack of mobility and the limitation in transmission power, stationary broadcasting may only provide limited field coverage. As a result, areas outside the field coverage may not receive DVB-T signals.

FIG. 1 is a schematic view illustrating a DVB-S/DVB-T base station and its field coverage in a communication system. Referring to FIG. 1, the system may include a DVB-S/DVB-T signal transceiving base station 100, which may refer to a construction on the ground or an apparatus on top of a construction, a satellite 200 for broadcasting TV programs that orbits around the Earth, and a plurality of digital TVs, for example, TVs 300, 300a and 300b, either stationary or mobile with respect to the station 100.

The satellite 200 broadcasts a DVB-S signal S1 that may contain at least a satellite program. The DVB-S/DVB-T signal transceiving base station 100 receives the DVB-S signal S1 and processes the signal S1 by, for example, editing, cutting, integrating, dubbing, synchronous translating, and/or captioning. Then, the processed signal is encoded so as to generate a corresponding DVB-T signal S2 containing the at least one satellite program. The DVB-S/DVB-T signal transceiving base station 100 broadcasts the DVB-T signal S2 in a field coverage ER0, which represents a range of the broadcasting service. In application, the range of the field coverage ER0 may be subject to the structure of the DVB-S/DVB-T signal transceiving base station 100, weather conditions and terrestrial features. Accordingly, the size of the field coverage ER0 may vary over time.

In the present example, the digital TV 300 is located within the field coverage ER0, while the other digital TVs 300a and 300b are located outside the field coverage ER0. Accordingly, only the digital TV 300 can receive the DVB-T signal S2 from the DVB-S/DVB-T signal transceiving base station 100 and display programs provided by the satellite 200 via the base station 100.

Due to the aforesaid limitations in stationary broadcasting, mobile broadcasting is introduced. In mobile broadcasting, an antenna system, which may be mounted on a satellite news gathering (SNG) vehicle, is used for tracking satellites and processing bi-directional signal and data communication when a target satellite is locked on.

FIG. 2 is a diagram illustrating a mobile satellite system 1 located outside the field coverage ER0 of the DVB-S/DVB-T signal transceiving base station 100. Referring to FIG. 2, the mobile satellite system 1 may be mounted on a vehicle such as an SNG vehicle in the vicinity of the digital TVs 300a and 300b for transmitting the satellite programs provided by the satellite 200. The mobile satellite system 1 includes a DVB-S antenna 11 and a DVB-T signal transceiver 12.

The DVB-S antenna 11 receives the DVB-S signal S1 from the satellite 200, forms a DVB-T signal S3 by editing the signal S1 and encoding the edited signal, and then broadcasts the signal S3 containing the satellite programs via the DVB-T signal transceiver 12. The mobile satellite system 1 may establish another field coverage ER′ to cover the digital TVs 300a and 300b within range of service. With such an arrangement, the digital TVs 300a and 300b can display the satellite programs provided by the satellite 200 through the mobile satellite system 1, while the digital TV 300 displays the satellite programs through the DVB-S/DVB-T signal transceiving base station 100.

Though the mobile broadcasting technology provides a solution to overcome the limitations of the stationary broadcasting technology, the mobile broadcasting technology may have some disadvantages yet to resolve, as discussed below.

Firstly, because the DVB-S signal S1 cannot be directly utilized by the digital TVs, the mobile satellite system 1 to serve as an intermediate station is generally required. Moreover, to facilitate the optimal performance of the mobile satellite system 1, a well-equipped SNG vehicle rather than general vehicles such as sedans, pickups, trucks and vans is often required, which may hinder mobile broadcasting from popularization.

Secondly, the DVB-S signal S1 needs to be processed to a certain extent in the mobile satellite system 1 before the processed signal is forwarded to clients (i.e., digital TVs). Such processing may incur additional cost and may inevitably result in a complicated mobile satellite system.

Thirdly, in the case that a favorite satellite program needs to be recorded while the user of the digital TV is not available, the mobile is satellite system 1 may not provide a delay download service or a relatively large memory for storing the favorite programs.

Fourthly, there is an increasing need for a portable multimedia memory device to record the programs broadcasted from the mobile satellite system 1 or directly from the satellite 200. Currently, the mobile satellite system 1 and some market products may not support this function.

Therefore, a need may exist for a more convenient mobile digital signal transceiving device. It may be desirable to have a device that is applicable to general vehicles and capable of downloading satellite programs.

### SUMMARY OF THE INVENTION

Accordingly, it is an object of the present invention to provide a mobile digital signal transceiving device, by which multimedia data stored in portable multimedia memory devices such as DVDs, CDs, MDs, SD cards and/or mobile disks can be retrieved and a corresponding radio frequency signal in a DVB-T format can be generated for a terrestrial broadcasting purpose so that the radio frequency signal may be received by at least a mobile multimedia apparatus.

It is another object of the present invention to provide a simple-structured mobile digital signal transceiving device for receiving a DVB-T signal, by which multimedia data carried by the DVB-T signal can be transformed in a DVB-T format into terrestrial broadcasting data and thereafter be further transformed into a radio frequency signal for broadcasting.

It is a further object of the present invention to provide a mobile digital signal transceiving device with a multimedia interface, with which the received DVB-T signal may be transformed into respective multimedia data to be thereafter stored in a portable multimedia memory device.

In the present invention, the mobile digital signal transceiving device includes a multimedia interface, a processing unit and a radio-frequency (RF) signal transmitter. The multimedia interface establishes a pathway for retrieving, reading and/or accessing at least one multimedia data from respective portable multimedia memory device. The processing unit may transform the multimedia data into corresponding terrestrial broadcast data in a DVB-T data format, and may form a corresponding RF signal based on the terrestrial broadcast data. The RF signal transmitter may transmit the RF signal so that the RF signal may be received by at least a mobile multimedia apparatus.

In a preferred embodiment of the present invention, the mobile digital signal transceiving device is mounted on a vehicle and may receive DVB-T signals transmitted from a DVB-S/DVB-T signal transceiving base station. In the case that the received DVB-T signal carries multimedia data, the mobile digital signal transceiving device of the present invention may transform the multimedia data into a terrestrial broadcast signal in the DVB-T data format, and transform the terrestrial broadcast signal into an RF signal for broadcasting. Then, all the mobile multimedia apparatuses within the field coverage of the mobile digital signal transceiving device may receive the RF signal corresponding to the DVB-T signal originally transmitted from a DVB-S/DVB-T signal transceiving base station.

In one embodiment of the present invention, the mobile digital signal transceiving device may be coupled with at least a multimedia R/W device, or built in a multimedia R/W unit, such that multimedia data stored in DVDs, CDs, MDs, SDs and portable hard disks may be readable. Also, the received DVB-T signal may be transformed into corresponding multimedia data, which may then be stored in the multimedia R/W device/unit.

In one embodiment of the present invention, a broader joint field coverage can be achieved by introducing at least two aforesaid mobile digital signal transceiving devices.

By providing the mobile digital signal transceiving device of the present invention to accompany the DVB-S/DVB-T signal transceiving base station, a field coverage of the base station may be substantially extended in an economical manner.

Since the mobile digital signal transceiving device of the present invention may be equipped with the multimedia interface, multimedia data stored in a portable multimedia memory device can be read and can be further transformed into a corresponding RF signal in a DVB-T data format, in which the RF signal can be preferably transmitted through at least a transmission band.

Furthermore, by providing the multimedia interface to the mobile digital signal transceiving device of the present invention, multimedia data carried by the DVB-T signal can be written into a portable multimedia memory device connected with the mobile digital signal transceiving device. With such an arrangement, the mobile digital signal transceiving device of the present invention needn't provide a large-scaled built-in memory, which may incur a substantial cost.

All these objects are achieved by the mobile digital signal transceiving device described below.

### BRIEF DESCRIPTION OF THE DRAWINGS

The present invention will be specified with reference to its preferred embodiments illustrated in the drawings, in which:

FIG. 1 is a schematic view illustrating a DVB-S/DVB-T base station with a field coverage;

FIG. 2 is a diagram illustrating a communication environment after adding a mobile satellite system to that of FIG. 1;

FIG. 3 is a schematic view of a mobile vehicle carrying a mobile digital signal transceiving device in accordance with an embodiment of the present invention;

FIG. 4 is a schematic view of a communication environment including one mobile digital signal transceiving device of the present invention;

FIG. 5 is a block diagram of a mobile digital transceiving device in accordance with an embodiment of the present invention;

FIG. 6 is a block diagram of a mobile digital transceiving device in accordance with another embodiment of the present invention; and

FIG. 7 is a schematic view of a communication environment including two mobile digital signal transceiving devices of the present invention.

### DESCRIPTION OF THE PREFERRED EMBODIMENT

The invention disclosed herein is directed to a mobile digital signal transceiving device. In the following description, numerous details are set forth in order to provide a thorough understanding of the present invention. It will be appreciated by one skilled in the art that variations of these specific details are possible while still achieving the results of the present invention. Under such a circumstance, there are two preferred embodiments described herein and a flowchart applied for both embodiments is provided to illustrate the present invention in details.

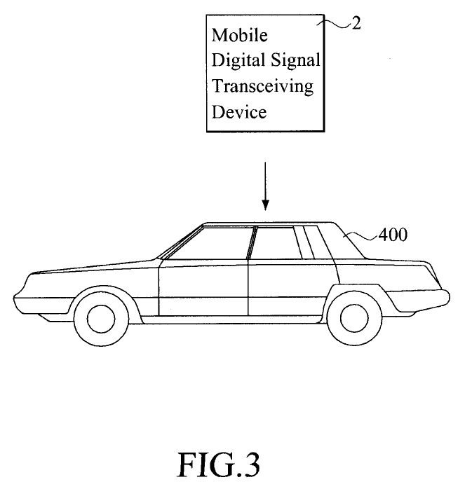

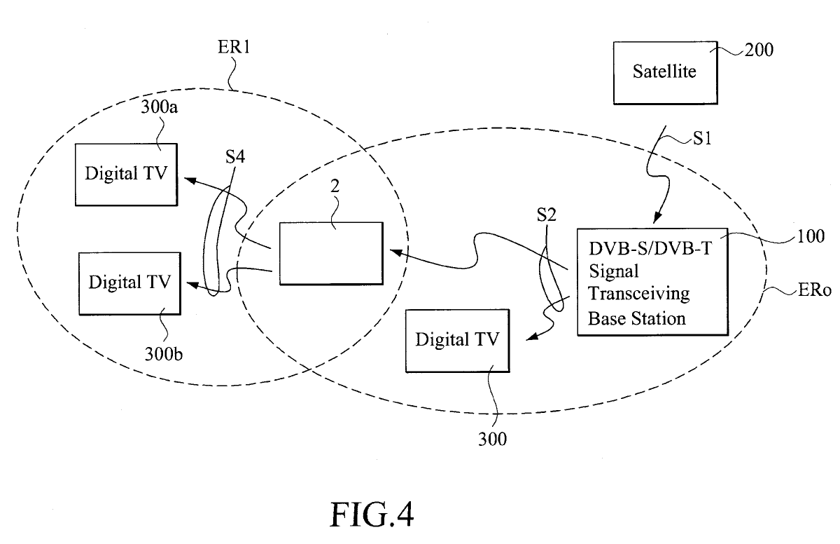

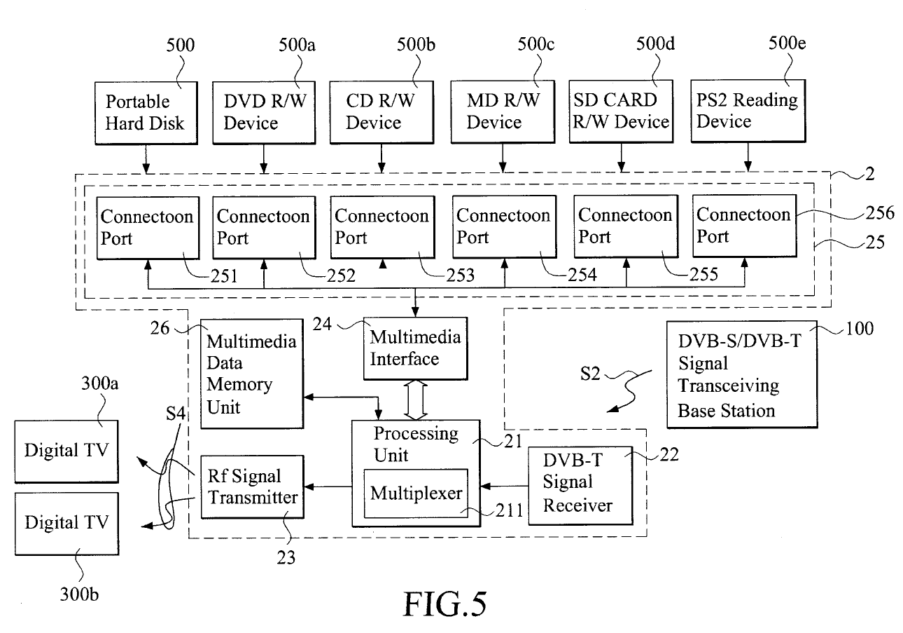

Referring now to FIG. 3 to FIG. 5, FIG. 3 illustrates a schematic view of a mobile vehicle carrying the mobile digital signal transceiving device in accordance with the present invention, FIG. 4 is a schematic view of a communication environment including one mobile digital signal transceiving device of the present invention, and FIG. 5 is a block diagram of a mobile digital transceiving device in accordance with an embodiment of the present invention. In the embodiment of the present invention, the mobile digital signal transceiving device 2 may be mounted on a vehicle 400, which may include a terrestrial, marine or aerial vehicle.

In the present invention, the mobile digital signal transceiving device 2 as shown in the embodiment may include a processing unit 21, a DVB-T signal receiver 22, an RF signal transmitter 23, a multimedia interface 24, a connection interface 25 and a multimedia data memory unit 26. The processing unit 21 further includes a multiplexer 211. The DVB-T signal receiver 22, the RF signal transmitter 23, the multimedia interface 24 and the multimedia data memory unit 26 are coupled electrically with the processing unit 21. The connection interface 25 includes, for example, six connection ports 251, 252, 253, 254, 255 and 256, each of which is coupled electrically with the multimedia interface 24.

A portable hard disk 500, a DVD R/W device 500a, a CD R/W device 500b, an MD W/R device 500c, an SD R/W device 500d and a PS (play station series by Sony ) reading device 500e are connected to the connection ports 251, 252, 253, 254, 255 and 256, respectively. The DVB-S/DVB-T signal transceiving base station 100 may be built on the ground or disposed on a construction. The program satellite 200 orbits in the space. A plurality of the mobile multimedia devices may be stationary or mobile devices. The mobile multimedia devices may include the digital TVs 300, 300a and 300b.

As previously described in the background, the DVB-S/DVB-T signal transceiving base station 100 may receive the DVB-S signal S1 and process the signal S1 by, for example, editing, cutting, integrating, dubbing, synchronous translating, and/or captioning. Then, the processed signal is encoded, thereby generating a corresponding DVB-T signal S2 carrying satellite programs. The DVB-S/DVB-T signal transceiving base station 100 broadcasts the DVB-T signal S2 in a field coverage ER0, which represents a range of the broadcasting service.

In application, due to the time-varying nature of the field coverage ER0, the field coverage ER0 may only cover the digital TV 300 and not the other digital TVs 300a and 300b at a certain time period. That is, only the digital TV 300 may effectively receive the DVB-T signal S2.

However, as the mobile digital signal transceiving device 2 of the present invention mounted on the vehicle 400 is moved to a position within the field coverage ER0, as illustrated in FIG. 4, the DVB-T signal receiver 22 may then receive the DVB-T signal S2 from the base station 100, and send the DVB-T signal S2 to the processing unit 21.

The processing unit 21 may decode the DVB-T signal S2 into multimedia data and then store the multimedia data in the multimedia data memory unit 26. Meanwhile, the processing unit 21 may transform the multimedia data into corresponding terrain broadcast data in a DVB-T data format, and then modulate the terrestrial broadcast data into an RF signal S4 based on a broadcast time sequence. The RF signal S4 is then sent to the RF signal transceiver 23. The RF signal transceiver 23 broadcasts the RF signal S4 simultaneously in at least a broadcast band within a field coverage ER1.

With the aforesaid arrangement, the digital TV 300a and 300b originally located outside the ER0 are covered by the ER1. Since the RF signal S4 is modulated from the terrestrial broadcast data in the DVB-T data format, the digital TVs 300a and 300b may directly transform the received RF signal S4 into corresponding multimedia data in order for display.

In addition, when the portable hard disk 500, DVD R/W device 500a, CD R/W device 500b, MD W/R device 500c, SD R/W device 500d and PS reading device 500e are correctly connected respectively to the connection ports 251, 252, 253, 254, 255 and 256, a DVD, a CD, an MD, an SD card and/or a PS2 disc may be put respectively into the portable hard disk 500, DVD R/W device 500a, CD R/W device 500b, MD W/R device 500c, SD R/W device 500d and/or the PS reading device 500e so that the portable multimedia storing means may retrieve the multimedia data stored in the multimedia data memory unit 26 through the multimedia interface 24. The retrieved multimedia data is then sent to the processing unit 21.

The processing unit 21 may process the multimedia data stored in one of the aforesaid portable multimedia storing means, or the multimedia data carried by the DVB-T signal S2, or both. In the case that both multimedia data are processed, the multiplexer 211 may perform a synchronized multiprocessing. In one embodiment, the multiplexer 211 may store multimedia data from different sources in the multimedia data memory unit 26. In another embodiment, the multiplexer 211 may transform the multimedia data into at least one terrestrial broadcast data in a DVB-T data format. The terrestrial broadcast data may be modulated into a corresponding RF signal S4, which may then be sent to the RF signal transmitter 23.

When the RF signal transmitter 23 broadcasts the RF signal S4, a plurality of broadcast bands may be available for multimedia data from various sources. For relatively large multimedia data, the multimedia data may be segmented into plural packages and then broadcast in the broadcast bands.

The use of multiple broadcast bands for transmitting the RF signal S4 in accordance with the present invention has at least the following advantages.

Firstly, by switching the channels of the digital TV 300a or 300b, specific multimedia data out of the plural multimedia data from various sources may be located for display. That is, the mobile digital signal transceiving device 2 may serve as a base station for TV programs. For example, in defining the channels, the multimedia data from the DVB-T signal may be assigned to Channel 1, those from the DVD may be assigned to Channel 2, those from the CD may be assigned to Channel 3, and so forth.

Secondly, for some multimedia data, it may be convenient to have the data segmented and then to present each segment to a corresponding channel of the digital TV 300a or 300b. With such an arrangement, a user may be allowed to choose a desired channel (a specific segment of the multimedia data) while skipping the other parts of the multimedia data. For example, a relatively long TV program may be segmented into three data packages during transmission, and the digital TV 300a may present the first data package to channel 1, the second data package to channel 2, and the third data package to channel 3.

Furthermore, in the case that the multimedia data memory unit 26 has excessive multimedia data, parts of the stored multimedia data may be moved to an external hard disk 500 through the multimedia interface 24, or written into the DVD, CD, MD, SD card and/or PS2 disc of the corresponding portable multimedia storing means. With such an arrangement, memory space in the multimedia data memory unit 26 may be timely released.

In the aforesaid first embodiment of the present invention, the connection ports 251, 252, 253, 254, 255 and 256 are utilized to connect externally to the hard disk 500, DVD R/W device 500a, CD R/W device 500b, MD R/W device 500c, SD card R/W device 500d and PS2 reading device 500e, respectively. In another embodiment of the present invention, some of the multimedia R/W devices may be built in the mobile digital signal transceiving device of the present invention.

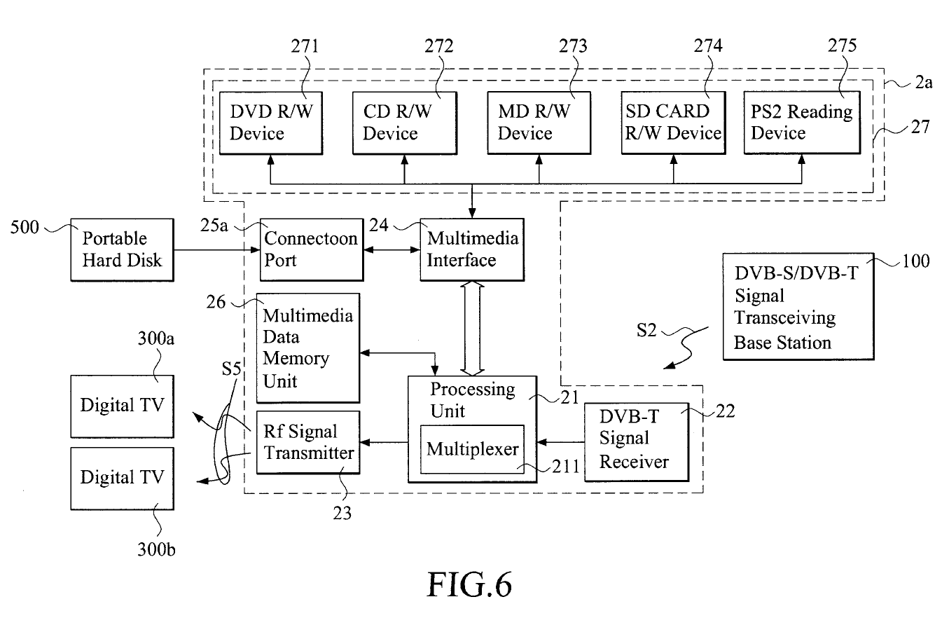

FIG. 6 is a block diagram of a mobile digital transceiving device 2a in accordance with another embodiment the present invention. As compared to the mobile digital transceiving device 2 of FIG. 5, the mobile digital signal transceiving device 2a includes a single connection port 25a, connecting externally to a portable hard disk 500, which replaces the aforesaid connection interface 25 illustrated in FIG. 5. Furthermore, the multimedia R/W devices 271-275 may be integrated as a built-in multimedia R/W unit 27 of the mobile digital signal transceiving device 2a that is directly coupled with the multimedia interface 24.

The connection port 25a is electrically coupled to the multimedia interface 24. The multimedia R/W unit 27 may include a DVD R/W device 271, a CD R/W device 272, an MD W/R device 273, an SD R/W device 274 and a PS2 reading device 275 for receiving multimedia data from a DVD, a CD, an MD, an SD card and a PS2 disc, respectively. Further, the mobile digital signal transceiving device 2a in this embodiment and the mobile digital signal transceiving device 2 illustrated in FIG. 5 are the same or at least similar in functions and operations. The RF signal emitted from the mobile digital signal transceiving device 2a is denoted as S5.

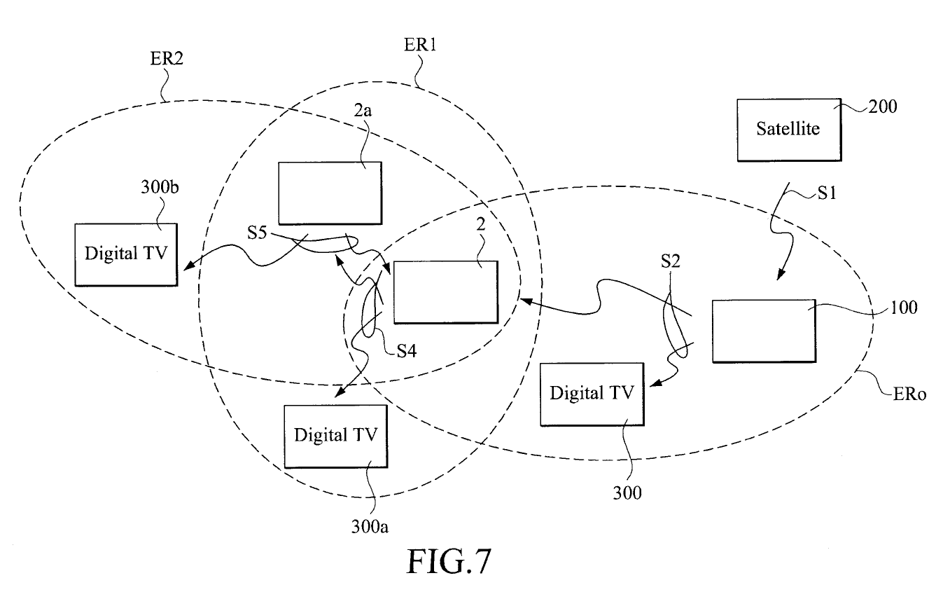

FIG. 7 is a schematic view of a communication environment including a satellite 200, a DVB-S/DVB-T signal transceiving base station 100, the mobile digital signal transceiving device 2, the mobile digital signal transceiving device 2a, and a plurality of digital TVs (three in the figure, 300, 300a and 300b). The DVB-S/DVB-T signal transceiving base station 100 receives the satellite signal S1 from the satellite and transmits the DVB-T signal S2 within the field coverage ER0. The mobile digital signal transceiving device 2 receives the DVB-T signal S2 from the base station 100 and transmits the RF signal S4 within the field coverage ER1. The mobile digital signal transceiving device 2a receives the RF signal S4 from the mobile digital signal transceiving device 2 and transmits the RF signal S5 within the field coverage ER2. With such an arrangement, the digital TV 300 may receive the DVB-T signal S2 from the base station 100, the digital TV 300a may receive the RF signal S4 from the mobile digital signal transceiving device 2, and the digital TV 300b may receive the RF signal S5 from the mobile digital signal transceiving device 2a.

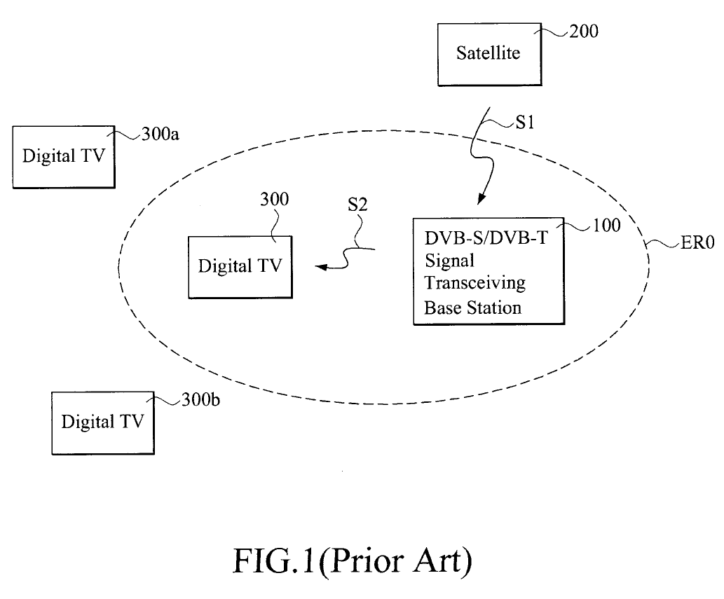

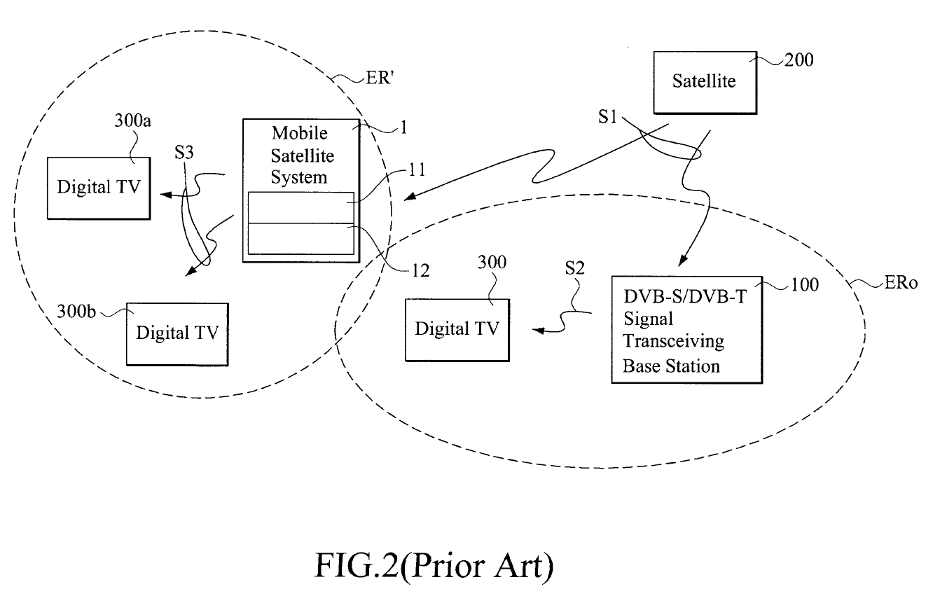

As compared to FIG. 1 and FIG. 2, the coverage of the satellite 200 is substantially extended by introducing the mobile digital signal transceiving devices 2 and 2a of the present invention.

The following advantages may be achieved.

1. Since the mobile digital signal transceiving device 2 or 2a of the present invention does not directly receive the DVB-S signal from the satellite 200, the mobile digital signal transceiving device 2 or 2a may have a simpler structure than the mobile satellite system 1 of FIG. 2. Also, the mobile digital signal transceiving device 2 or 2a may be easily mounted or carried by an ordinary vehicle, and thus the cost in constructing a carrier and providing sufficient instruments/parts to utilize the DVB-T signal may be substantially reduced.

2. By providing the multimedia interface to the mobile digital signal transceiving device 2 or 2a, various multimedia data stored in most of the media storage means become available from the mobile digital signal transceiving device 2 or 2a to the digital TVs.

3. In the case that the mobile digital signal transceiving device receives too-big-to-be-handled multimedia data carried by the DVB-T signal, the multimedia interface may write the multimedia data into a portable multimedia memory device. Therefore, when the multimedia data are to be broadcasted at a later time, the multimedia data may be readily available from the portable multimedia memory device. With such an arrangement, the mobile digital signal transceiving device needn't construct a built-in memory unit for storing huge multimedia data.

4. In the case that at least two mobile digital signal transceiving devices are applied to the DVB-T/DVB-S base station, the integrated field coverage may be substantially enlarged to cover more stationary or mobile multimedia display devices under service.

5. Though the mobile multimedia display devices used in the aforesaid embodiment of the present invention are defined to be the digital TVs, the mobile multimedia display devices in other embodiments may include any devices that can handle and display the RF signal in a DVB-T data format.

The aforesaid mobile digital signal transceiving device 2 or 2a is portable and thus may be carried by a vehicle 400, or removed from the vehicle 400 and used indoor or outdoor as a stationary unit.

While the present invention has been particularly shown and described with reference to a preferred embodiment, it will be understood by those skilled in the art that various changes in form and detail may be without departing from the spirit and scope of the present invention.

I claim:

1. A mobile digital signal transceiving device to broadcast a radio-frequency (RF) signal in a digital video broadcasting-terrestrial (DVB-T) data format, the mobile digital signal transceiving device comprising:
a multimedia interface for accessing at least a multimedia data stored in at least a portable multimedia memory device;
a processing unit, coupled with the multimedia interface, for transforming the multimedia data into at least a terrestrial broadcast data in the DVB-T data format and modulating the terrestrial broadcast data into the RF signal; and
an RF signal transmitter, coupled with the processing unit, for transmitting the RF signal so that the RF signal is received by at least one mobile multimedia device.

2. The mobile digital signal transceiving device according to claim 1, further including multimedia data memory unit coupled with said processing unit for storing said multimedia data.

3. The mobile digital signal transceiving device according to claim 1, further including a DVB-T receiver coupled with said processing unit for receiving a DVB-T signal, the DVB-T signal being transformed into said RF signal by said processing unit.

4. The mobile digital signal transceiving device according to claim 3, wherein said DVB-T signal is a signal transmitted by a digital video broadcasting-satellite (DVB-S)/DVB-T signal transceiving base station.

5. The mobile digital signal transceiving device according to claim 1, further including at least a connection port coupled with said multimedia interface for providing further connection to at least a multimedia read/write (R/W) device, the multimedia R/W being used for reading said multimedia data stored in said portable multimedia memory device.

6. The mobile digital signal transceiving device according to claim 1, wherein said multimedia R/W device includes one of a DVD R/W device, a CD R/W device, an MD W/R device, an SD R/W device, a portable hard disk and a PS2 reading device.

7. The mobile digital signal transceiving device according to claim 1, further including a multimedia R/W unit coupled with said multimedia interface for reading said multimedia data stored in said portable multimedia memory device.

8. The mobile digital signal transceiving device according to claim 7, wherein said multimedia R/W unit includes one of a DVD R/W device, a CD R/W device, an MD W/R device, an SD R/W device and a PS2 reading device.

9. The mobile digital signal transceiving device according to claim 7, further including at least a connection port coupled with said multimedia interface for providing further connection to at least a multimedia read/write (R/W) device, the multimedia R/W being used for reading said multimedia data stored in said portable multimedia memory device.

10. The mobile digital signal transceiving device according to claim 1, wherein said processing unit further includes a multiplexer for performing a synchronized multiprocessing upon said multimedia data.

11. The mobile digital signal transceiving device according to claim 1, wherein said mobile multimedia device is a digital TV.
